(19) United States
(12) Patent Application Publication
(10) Pub. No.: US 2026/0111531 A1
(43) Pub. Date: Apr. 23, 2026

(54) APPLICATION-SELECTIVE VEHICLE STATE BASED API ACCESS PROHIBITION

(71) Applicant: TOYOTA JIDOSHA KABUSHIKI KAISHA, Aichi-ken (JP)

(72) Inventors: Yuichi YOSHIMURA, Kawasaki-shi (JP); Mitsuo DATE, Funabashi-shi (JP); Yutaka TARUOKA, Anjo-shi (JP)

(21) Appl. No.: 18/924,962

(22) Filed: Oct. 23, 2024

(51) Int. Cl. G06F 21/44

(52) U.S. Cl. CPC G06F 21/44

(57) ABSTRACT

Application-selective vehicle state based API access prohibition is implemented by receiving a command to execute an application, determining whether the application is in a first group of applications, detecting whether a vehicle is in a parked state in response to determining that the application is in the first group, and prohibiting the application from access to one or more Application Programming Interfaces (APIs) of the vehicle based on whether the vehicle is in the parked state.

### BACKGROUND

A vehicle system is composed of many Electronic Controller Units (ECUs). Many ECUs are able to function as computers, with the ability to access externally-stored data and communicate through packet-based networks. Software applications are executed by ECUs to provide various services for the vehicle or a user thereof. Software applications request vehicle information through an Application Programming Interface (API).

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a system for application-selective vehicle state based API access prohibition, according to at least some embodiments of the subject disclosure.

FIG. 2 is an operational flow for API access management, according to at least some embodiments of the subject disclosure.

FIG. 3 is an operational flow for application-selective vehicle state based API access prohibition, according to at least some embodiments of the subject disclosure.

FIG. 4 is a block diagram of a hardware configuration for application-selective vehicle state based API access prohibition, according to at least some embodiments of the subject disclosure.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

Exposing APIs for access to vehicle data and vehicle control to different applications, such as Original Equipment Manufacturer (OEM) applications or third-party applications, raises a variety of risks. Managing such access to the APIs enables those risks to be reduced, mitigated, or avoided. Although various types of applications designed to be suitable for execution on the vehicle, certain applications are not suitable for execution while the vehicle is running, and other applications are not suitable for execution while the vehicle is stopped.

In at least some embodiments described herein, access to the vehicle APIs from a first group of applications is prohibited based on whether the vehicle is in motion. In at least some embodiments, access from the first group of applications is prohibited while the vehicle is in a parked state. In at least some embodiments, access from the first group of applications is prohibited while the vehicle is not in a parked state. In at least some embodiments, access from the first group of applications is prohibited while the vehicle is in a parked state, and access from a second group of applications is prohibited while the vehicle is not in a parked state. In at least some embodiments, a “parked” state is understood as stopped, not being driven, not moving, etc.

In at least some embodiments, appropriately managing access from applications to the vehicle APIs based on whether the vehicle is parked enables enhanced safety of the vehicle.

In at least some embodiments, the first group of applications includes applications that are likely to distract a driver's attention. In at least some embodiments, the first group of applications includes gaming applications, applications for browsing information, such as news, videos, websites, etc., or any other application utilizing a display to generate visual content. In at least some embodiments, the first group of applications includes applications that are not operable by voice input. In at least some embodiments, the operability of voice input is determined from presence or absence of VUI (Voice User Interface) operations during previous execution of the application. In at least some embodiments, the first group of applications includes applications that affect the vehicle operation, such as applications for seat adjustment, applications for setting driving mode, etc., and applications whose operation has not yet been verified. In at least some embodiments, access from a second group of applications to the vehicle APIs of is prohibited while the vehicle is stopped. In at least some embodiments, the second group of applications includes applications configured to affect vehicle operation, such as acceleration, braking, steering, etc. In at least some embodiments, access from all of applications to the vehicle APIs is prohibited while the vehicle is stopped and performing an OTA (Over The Air) operation, such as updating vehicle firmware. In at least some embodiments, access from all of applications to the vehicle APIs is prohibited while the vehicle is stopped and undergoing charging of a battery. In at least some embodiments, prohibiting API access while the vehicle is stopped and undergoing charging enables improved charging efficiency, prevention of battery degradation, prevention of over-occupation of the charging station, etc.

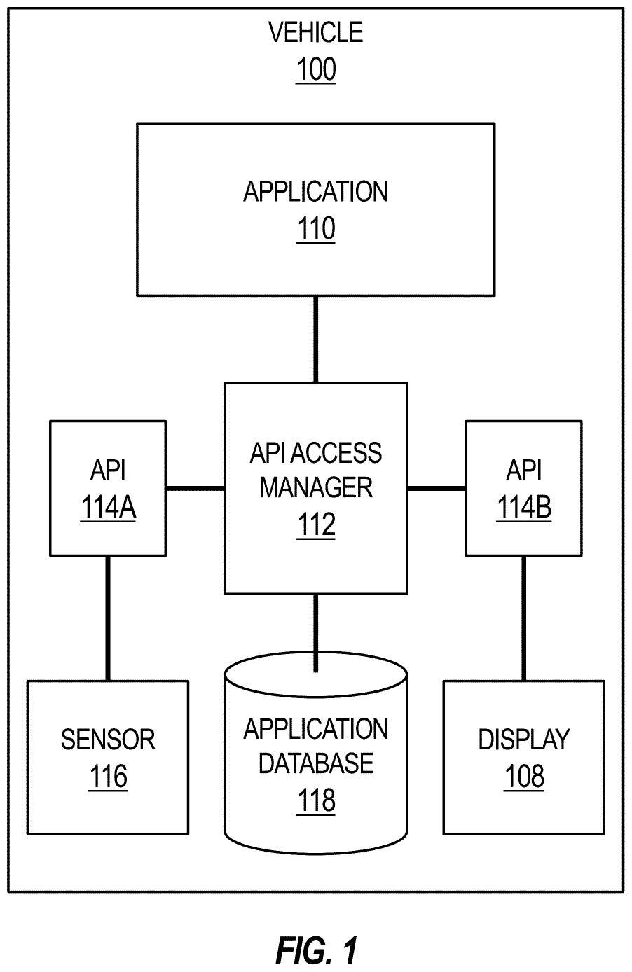

FIG. 1 is a schematic diagram of a system for application-selective vehicle state based API access prohibition, according to at least some embodiments of the subject disclosure. The system for application-selective vehicle state based API access prohibition includes vehicle 100, application 110, API access manager 112, API 114A and 114B, sensor 114, application database 116, and display 108.

Vehicle 100 is a component of the system for application-selective vehicle state-based API access prohibition. In at least some embodiments, vehicle 100 is in the form of a car, truck, or any other type of vehicle, such as those commonly used for personal transportation, commercial transportation, etc. In at least some embodiments, vehicle 100 includes entertainment systems, climate control, etc. In at least some embodiments, vehicle 100 is configured to provide power and network connectivity. In at least some embodiments, vehicle 100 is configured to interface with user devices. In at least some embodiments, vehicle 100 is configured to connect to charging stations.

Application 110 is a component of the system for application-selective vehicle state-based API access prohibition. In at least some embodiments, application 110 is in the form of a mobile app, embedded software program, or vehicle-specific application, such as those commonly used in mobile devices, smart home integration, wearable devices, etc. In at least some embodiments, application 110 is configured to perform background updates, non-critical notifications, etc. In at least some embodiments, application 110 is configured to request vehicle data, provide services to users, etc. In at least some embodiments, application 110 is configured to transmit requests to API access manager 112, transmit and receive data through APIs. In at least some embodiments, application 110 is configured to interact with peripherals, such as sensor 116 and display 108.

API access manager 112 is a component of the system for application-selective vehicle state-based API access prohibition. In at least some embodiments, API access manager 112 is implemented as middleware software, API gateways, security modules, etc. In at least some embodiments, API access manager 112 is of the type commonly used in enterprise API management, IoT device management, cloud services, etc. In at least some embodiments, API access manager 112 is configured to log non-critical data and includes debugging tools. In at least some embodiments, API access manager 112 is configured to manage API access, enforce access rules, monitor vehicle state, etc. In at least some embodiments, API access manager 112 is configured to receive commands from applications, communicate with APIs, interface with sensors, etc.

APIs 114A and 114B are components of the system for application-selective vehicle state-based API access prohibition. In at least some embodiments, API 114A and 114B are provided as RESTful APIs, SOAP APIs, GraphQL APIs, etc. In at least some embodiments, API 114A and 114B are of the type commonly used in web services, mobile app backends, IoT device interfaces, etc. In at least some embodiments, API 114A and 114B are configured to provide vehicle data, control vehicle functions, interface with applications, etc.

Sensor 114 is a component of the system for application-selective vehicle state-based API access prohibition. In at least some embodiments, sensor 114 is in the form of a speedometer, accelerometer, transmission gear sensor, etc. In at least some embodiments, vehicle 100 includes more than one sensor 114 to detect more than one type of information. In at least some embodiments, sensor 114 is of the type commonly used in consumer vehicles, commercial vehicles, autonomously driving vehicles, industrial automation, environmental monitoring, smart home devices, etc. In at least some embodiments, sensor 114 is configured to detect vehicle state, provide data to API access manager 112, monitor vehicle conditions, etc.

Application database 116 is a component of the system for application-selective vehicle state-based API access prohibition. In at least some embodiments, application database 116 is implemented as one or more SQL databases, NoSQL databases, cloud-based storage solutions, etc. In at least some embodiments, application database 116 is commonly used in enterprise data management, cloud services, mobile app backends, etc. In at least some embodiments, application database 116 is configured to store application data, manage application states, provide data to API access manager 112, etc. In at least some embodiments, application database 116 is configured to interface with API access manager 112, store application permissions, communicate with applications, etc.

Display 108 is a component of the system for application-selective vehicle state-based API access prohibition. In at least some embodiments, display 108 includes one or more of touchscreen displays, heads-up displays, or infotainment screens. In at least some embodiments, display 108 is of the type commonly used in consumer electronics, industrial control panels, smart home devices, etc. In at least some embodiments, display 108 is configured to show application interfaces, provide user feedback, display vehicle data, etc. In at least some embodiments, display 108 is configured to receive data from applications, interface with vehicle systems, communicate with ECUs, etc.

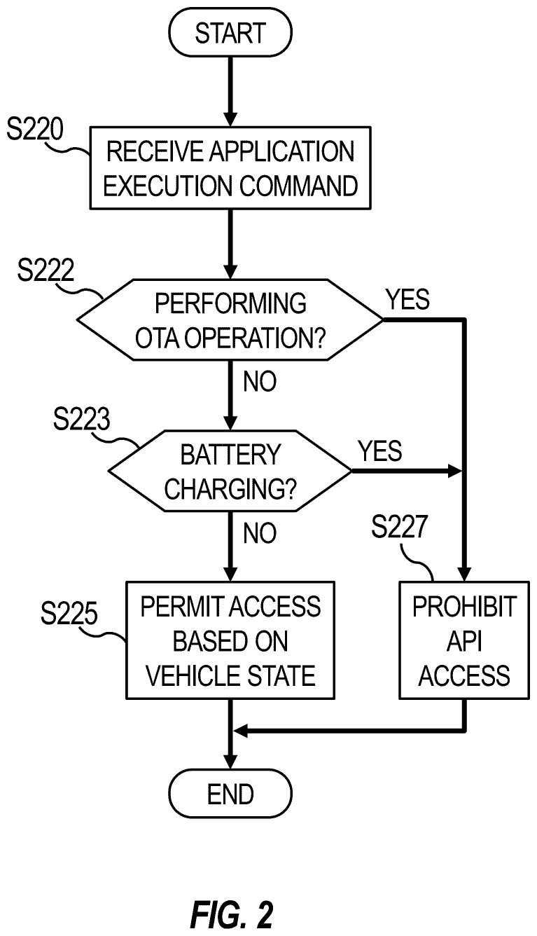

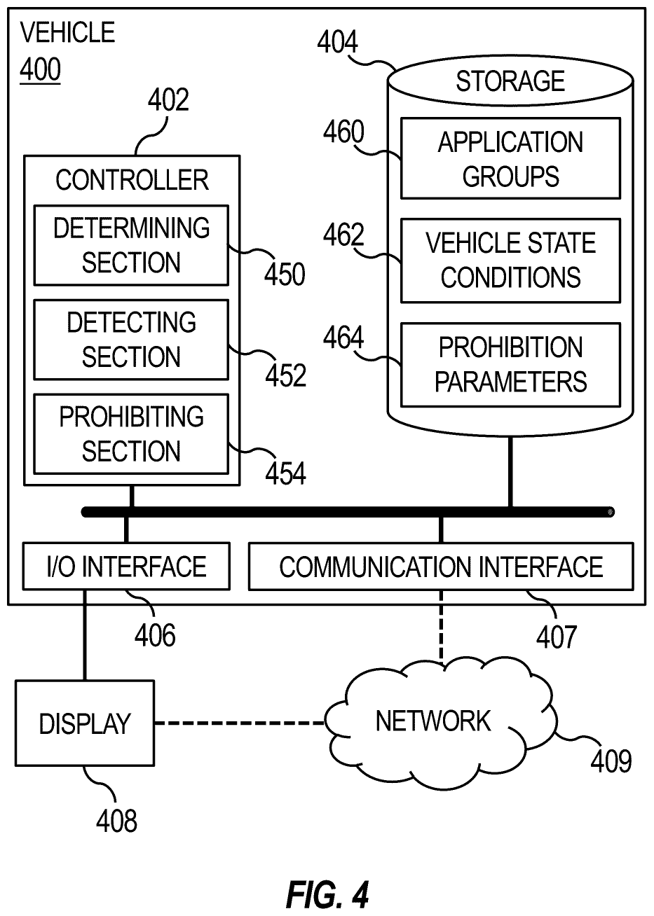

FIG. 2 is an operational flow for API access management, according to at least some embodiments of the subject disclosure. In at least some embodiments, the operational flow provides a method of API access management. In at least some embodiments, the method is performed by a controller of a vehicle, such as controller 402 of vehicle 400 of FIG. 4, described hereinafter.

At S220, the controller or a section thereof receives an application execution command. In at least some embodiments, the controller receives a command to execute an application. In at least some embodiments, the controller listens for incoming commands, validates the command format, and identifies the application to be executed. In at least some embodiments, the controller logs the command for audit purposes, providing traceability.

At S222, the controller or a section thereof determines whether an Over-The-Air (OTA) operation is being performed. In at least some embodiments, the controller detects an OTA operation. In at least some embodiments, the controller checks the OTA status and verifies the requirements for the OTA operation. In at least some embodiments, in response to an OTA operation being in progress, the controller prioritizes this operation by delaying non-critical tasks and prohibiting access to the vehicle APIs for other applications. In response to the controller determining that an OTA operation is being performed, the operational flow proceeds to API access prohibition at S227. In response to the controller determining that an OTA operation is not being performed, the operational flow proceeds to battery charging determination at S223.

At S223, the controller or a section thereof determines whether the vehicle battery is charging. In at least some embodiments, the controller detects a battery-charge operation. In at least some embodiments, the controller monitors the vehicle's battery status to detect if the vehicle is in a charging state. In at least some embodiments, the controller uses battery sensors and feedback from the charging system to determine the charging state. In at least some embodiments, in response to the vehicle being in a charging state, the controller prohibits access to the vehicle APIs for certain applications to manage power distribution and prevent overloading. In response to the controller determining that the vehicle battery is charging, the operational flow proceeds to API access prohibition at S227. In response to the controller determining that the vehicle battery is not charging, the operational flow proceeds to vehicle state based access permission at S225.

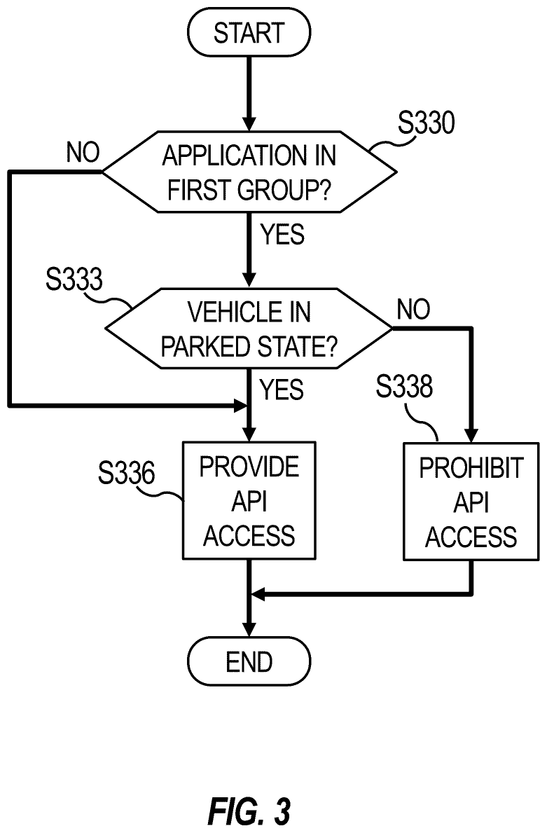

At S225, the controller or a section thereof permits access based on the vehicle state. In at least some embodiments, the controller permits access to the vehicle APIs only when the vehicle is in predetermined states. In at least some embodiments, the controller checks the vehicle state using various sensors and compares the vehicle state with rules defined for different application groups. In at least some embodiments, the controller performs this process to ensure that applications are used safely and appropriately, enhancing the user experience while maintaining safety protocols. In at least some embodiments, the controller performs the operational flow of FIG. 3, described hereinafter.

At S227, the controller or a section thereof prohibits API access. In at least some embodiments, the controller prohibits the application from access to the one or more APIs of the vehicle in response to detecting that the vehicle is performing an OTA operation. In at least some embodiments, the controller prohibits the application from access to the one or more APIs of the vehicle in response to detecting that the vehicle is performing a charging operation. In at least some embodiments, the controller prohibits API access regardless of whether the vehicle is in a parked state. In at least some embodiments, the controller denies any requests directed toward APIs of the vehicle. In at least some embodiments, the controller blocks the application from accessing the APIs.

FIG. 3 is an operational flow for application-selective vehicle state based API access prohibition, according to at least some embodiments of the subject disclosure. In at least some embodiments, the operational flow provides a method of application-selective vehicle state based API access prohibition. In at least some embodiments, the method is performed by a controller of a vehicle, such as controller 402 of vehicle 400 of FIG. 4, described hereinafter.

At S330, the controller or a section thereof determines whether the application is in a first group of applications. In at least some embodiments, the controller retrieves the application ID and checks the application ID against a database of application groups. In at least some embodiments, the controller compares the application ID with the list of applications in the first group. In at least some embodiments, based on this comparison, the controller categorizes the application and determines the next steps. In response to the controller determining that the application is in the first group, the controller proceeds to vehicle state detection at S333. In response to determining that the application is not in the first group, the controller proceeds to API access provision at S336.

At S333, the controller or a section thereof detects whether the vehicle is in a parked state. In at least some embodiments, the controller detects whether a vehicle is in a parked state in response to determining that the application is in the first group. In at least some embodiments, the controller reads data from vehicle sensors, such as the speedometer, accelerometer, transmission gear sensor, or any combination thereof. In at least some embodiments, the controller analyzes this sensor data to determine whether the vehicle is in a parked state. In at least some embodiments, the detecting is based on at least one of a speedometer, accelerometer, or transmission gear sensor. In at least some embodiments, the controller identifies the vehicle state and uses this information as a decision point for API access. In response to determining that the vehicle is not in a parked state, the controller proceeds to prohibit API access at S338. In response to determining that the vehicle is in a parked state, the controller proceeds to provide API access at S336.

At S336, the controller or a section thereof provides API access. In at least some embodiments, the controller authenticates the application and grants API access tokens. In at least some embodiments, the controller logs the access event for auditing purposes. In at least some embodiments, the controller performs this operation to ensure that legitimate applications function properly and enhances the user experience by maintaining system integrity.

At S338, the controller or a section thereof prohibits API access. In at least some embodiments, the controller prohibits the application from access to one or more APIs of the vehicle based on whether the vehicle is in the parked state. In at least some embodiments, the controller prohibits the application in response to detecting that the vehicle is not in the parked state. In at least some embodiments, the controller denies API access tokens and logs the prohibition event for auditing purposes. In at least some embodiments, the controller notifies the application of the prohibition, so that the application is aware of the denied access. In at least some embodiments, the controller performs this operation to enhance vehicle safety by protecting sensitive vehicle data and preventing unauthorized access.

In the embodiment shown in FIG. 3, applications in the first group of applications are prohibited from API access in response to determining that the vehicle is not in the parked state, and are provided API access in response to determining that the vehicle is in the parked state. In at least some of such embodiments, the first group of applications includes applications that distract the driver's attention. In at least some embodiments, the first group of applications includes applications that affect the vehicle operation. In at least some embodiments, the first group of applications includes applications that cannot be operated by voice input. In at least some other embodiments, applications in the first group of applications are prohibited from API access in response to determining that the vehicle is in the parked state, and are provided API access in response to determining that the vehicle is not in the parked state. In at least some of such embodiments, the first group of applications includes applications with vehicle operation. In at least some embodiments, application-selective vehicle state based API access prohibition applies to multiple groups of applications. In at least some embodiments, applications in the first group of applications are prohibited from API access in response to determining that the vehicle is not in the parked state, and applications in a second group of applications are prohibited from API access in response to determining that the vehicle is in the parked state.

FIG. 4 is a block diagram of a hardware configuration for application-selective vehicle state based API access prohibition, according to at least some embodiments of the subject disclosure. The hardware configuration includes vehicle 400, which interacts with display 408 directly or through network 409. In at least some embodiments, display 408 is a touch screen, a microphone, a camera, or any other device configured to detect tactile, aural, visual, etc. input. In at least some embodiments, network 409 is an ethernet network, a Controller Area Network (CAN), or any other wired or wireless network or a combination thereof. In at least some embodiments, vehicle 400 is a computer or other computing device that receives input or commands from display 408. In at least some embodiments, vehicle 400 is integrated with display 408. In at least some embodiments, vehicle 400 is a computer system that executes computer-readable instructions to perform operations for application-selective vehicle state based API access prohibition.

Vehicle 400 includes controller 402, storage 404, input/output interface 406, and communication interface 407. In at least some embodiments, controller 402 includes a processor or programmable circuitry executing instructions to cause the processor or programmable circuitry to perform operations according to the instructions. In at least some embodiments, controller 402 includes analog or digital programmable circuitry, or any combination thereof. In at least some embodiments, controller 402 includes physically separated storage or circuitry that interacts through communication. In at least some embodiments, storage 404 includes a non-volatile computer-readable medium capable of storing executable and non-executable data for access by controller 402 during execution of the instructions. In at least some embodiments, communication interface 407 transmits and receives data from network 409. In at least some embodiments, input/output interface 406 connects to various input and output units, such as display 408, via a parallel port, a serial port, a keyboard port, a mouse port, a monitor port, and the like to accept commands and present information. In some embodiments, storage 404 is external from vehicle 400.

Controller 402 includes determining section 450, detecting section 452, and prohibiting section 454. storage 404 includes application groups 460, vehicle state conditions 462, and prohibition parameters 464.

Determining section 450 is the circuitry or instructions of controller 402 configured to determine group membership of applications. In at least some embodiments, determining section 450 is configured to determine whether an application is in a first group of applications. In at least some embodiments, determining section 450 utilizes storage 404 to read or record information, such as application groups 460. In at least some embodiments, determining section 450 includes sub-sections for performing additional functions, as described in the foregoing flow charts. In at least some embodiments, such sub-sections are referred to by a name associated with a corresponding function.

Detecting section 452 is the circuitry or instructions of controller 402 configured for vehicle state detection. In at least some embodiments, detecting section 452 is configured to detect whether a vehicle is in a parked state in response to determining that the application is in the first group. In at least some embodiments, detecting section 452 utilizes storage 404 to read or record information, such as vehicle state conditions 462. In at least some embodiments, detecting section 452 includes sub-sections for performing additional functions, as described in the foregoing flow charts. In at least some embodiments, such sub-sections are referred to by a name associated with a corresponding function.

Prohibiting section 454 is the circuitry or instructions of controller 402 configured for API access prohibition. In at least some embodiments, prohibiting section 454 is configured to prohibit the application from access to one or more Application Programming Interfaces (APIs) of the vehicle based on whether the vehicle is in the parked state. In at least some embodiments, prohibiting section 454 utilizes storage 404 to read or record information, such as prohibition parameters 464. In at least some embodiments, prohibiting section 454 includes sub-sections for performing additional functions, as described in the foregoing flow charts. In at least some embodiments, such sub-sections are referred to by a name associated with a corresponding function.

In at least some embodiments, the vehicle is another device capable of processing logical functions in order to perform the operations herein. In at least some embodiments, the controller and the storage need not be entirely separate devices, but share circuitry or one or more computer-readable mediums. In at least some embodiments, the storage includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the vehicle is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of hardware responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer-readable medium includes a tangible device that is able to retain and store instructions for use by an instruction execution device. In some embodiments, the computer-readable medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

While embodiments of the present invention have been described, the technical scope of any subject matter claimed is not limited to the above described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

Application-selective vehicle state based API access prohibition is implemented by receiving a command to execute an application, determining whether the application is in a first group of applications, detecting whether a vehicle is in a parked state in response to determining that the application is in the first group, and prohibiting the application from access to one or more Application Programming Interfaces (APIs) of the vehicle based on whether the vehicle is in the parked state.

In at least some embodiments, the prohibiting includes prohibiting the first group of applications in response to detecting that the vehicle is not in the parked state. In at least some embodiments, the first group of applications includes applications that distract the driver's attention. In at least some embodiments, the first group of applications includes applications that affect the vehicle operation. In at least some embodiments, the first group of applications includes applications that cannot be operated by voice input. In at least some embodiments, the prohibiting includes prohibiting the first group of applications in response to detecting that the vehicle is in the parked state. In at least some embodiments, the first group of applications includes applications with vehicle operation. In at least some embodiments, the detecting is based on at least one of a speedometer, accelerometer, or transmission gear sensor. In at least some embodiments, application-selective vehicle state based API access prohibition is further implemented by detecting an OTA operation; prohibiting the application from access to the one or more APIs of the vehicle in response to detecting that the vehicle is in the parked state and performing an OTA operation. In at least some embodiments, application-selective vehicle state based API access prohibition is further implemented by detecting a battery-charge operation; prohibiting the application from access to the one or more APIs of the vehicle in response to detecting that the vehicle is in the parked state and performing a charging operation.

Application-selective vehicle state based API access prohibition is implemented by receiving a command to execute an application, determining whether the application is in a first group of applications, detecting whether a vehicle is in a parked state in response to determining that the application is in the first group, and prohibiting the application from access to one or more Application Programming Interfaces (APIs) of the vehicle based on whether the vehicle is in the parked state.

In at least some embodiments, the prohibiting includes prohibiting the first group of applications in response to detecting that the vehicle is not in the parked state. In at least some embodiments, the first group of applications includes applications that distract the driver's attention. In at least some embodiments, the prohibiting includes prohibiting the first group of applications in response to detecting that the vehicle is in the parked state. In at least some embodiments, the first group of applications includes applications with vehicle operation.

Application-selective vehicle state based API access prohibition is implemented by a controller including circuitry configured to perform operations including:, receiving a command to execute an application, determining whether the application is in a first group of applications, detecting whether a vehicle is in a parked state in response to determining that the application is in the first group, and prohibiting the application from access to one or more Application Programming Interfaces (APIs) of the vehicle based on whether the vehicle is in the parked state.

In at least some embodiments, the prohibiting includes prohibiting the first group of applications in response to detecting that the vehicle is not in the parked state. In at least some embodiments, the first group of applications includes applications that distract the driver's attention. In at least some embodiments, the prohibiting includes prohibiting the first group of applications in response to detecting that the vehicle is in the parked state. In at least some embodiments, the first group of applications includes applications with vehicle operation.

The foregoing outlines features of several embodiments so that those skilled in the art would better understand the aspects of the present disclosure. Those skilled in the art should appreciate that this disclosure is readily usable as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that various changes, substitutions, and alterations herein are possible without departing from the spirit and scope of the present disclosure.

What is claimed is:

1. A non-transitory computer-readable medium including instructions that, in response to execution by one or more processors, cause performance of operations comprising:
receiving a command to execute an application;
determining whether the application is in a first group of applications;
detecting whether a vehicle is in a parked state in response to determining that the application is in the first group; and
prohibiting the application from access to one or more Application Programming Interfaces (APIs) of the vehicle based on whether the vehicle is in the parked state.

2. The computer-readable medium of claim 1, wherein the prohibiting includes prohibiting the first group of applications in response to detecting that the vehicle is not in the parked state.

3. The computer-readable medium of claim 2, wherein the first group of applications includes applications that distract the driver's attention.

4. The computer-readable medium of claim 2, wherein the first group of applications includes applications that affect the vehicle operation.

5. The computer-readable medium of claim 2, wherein the first group of applications includes applications that cannot be operated by voice input.

6. The computer-readable medium of claim 1, wherein the prohibiting includes prohibiting the first group of applications in response to detecting that the vehicle is in the parked state.

7. The computer-readable medium of claim 6, wherein the first group of applications includes applications with vehicle operation.

8. The computer-readable medium of claim 1, wherein the detecting is based on at least one of a speedometer, accelerometer, or transmission gear sensor.

9. The computer-readable medium of claim 1, further comprising
detecting an OTA operation;
prohibiting the application from access to the one or more APIs of the vehicle in response to detecting that the vehicle is performing an OTA operation.

10. The computer-readable medium of claim 1, further comprising
detecting a battery-charge operation;
prohibiting the application from access to the one or more APIs of the vehicle in response to detecting that the vehicle is performing a charging operation.

11. A method comprising:
receiving a command to execute an application;
determining whether the application is in a first group of applications;
detecting whether a vehicle is in a parked state in response to determining that the application is in the first group; and
prohibiting the application from access to one or more Application Programming Interfaces (APIs) of the vehicle based on whether the vehicle is in the parked state.

12. The method of claim 11, wherein the prohibiting includes prohibiting the first group of applications in response to detecting that the vehicle is not in the parked state.

13. The method of claim 12, wherein the first group of applications includes applications that distract the driver's attention.

14. The method of claim 11, wherein the prohibiting includes prohibiting the first group of applications in response to detecting that the vehicle is in the parked state.

15. The method of claim 14, wherein the first group of applications includes applications with vehicle operation.

16. A device comprising:
a controller including circuitry configured to perform operations including:
receiving a command to execute an application,
determining whether the application is in a first group of applications,
detecting whether a vehicle is in a parked state in response to determining that the application is in the first group, and
prohibiting the application from access to one or more Application Programming Interfaces (APIs) of the vehicle based on whether the vehicle is in the parked state.

17. The device of claim 16, wherein the prohibiting includes prohibiting the first group of applications in response to detecting that the vehicle is not in the parked state.

18. The device of claim 17, wherein the first group of applications includes applications that distract the driver's attention.

19. The device of claim 16, wherein the prohibiting includes prohibiting the first group of applications in response to detecting that the vehicle is in the parked state.

20. The device of claim 19, wherein the first group of applications includes applications with vehicle operation.
